(19) United States
(12) Patent Application Publication
(10) Pub. No.: US 2006/0218767 A1
(43) Pub. Date: Oct. 5, 2006

(54) Framing apparatus for car body welding station

(75) Inventor: Velibor Kilibarda, Birmingham, MI (US)

Correspondence Address: YOUNG & BASILE, P.C., 3001 WEST BIG BEAVER ROAD, SUITE 624, TROY, MI, 48084, US

(73) Assignee: Progressive Tool & Industries, Co., Southfield, MI (US)

(21) Appl. No.: 11/398,280

(22) Filed: Apr. 5, 2006

Related U.S. Application Data
(60) Provisional application No. 60/668,261, filed on Apr. 5, 2005.

(51) Int. Cl. B25B 27/14; B23Q 1/00

(52) U.S. Cl. 29/281.6; 29/281.1; 29/283

(57) ABSTRACT

A car body framing apparatus for use at a welding station for welding a plurality of loosely assembled vehicle body components. The apparatus includes a gate having an open frame structure including skeletal members and tooling members mounted on the frame structure by a plurality of mounting brackets. Each mounting bracket includes a planar platform structure mounting a respective tooling member and a U-shaped mounting structure sized to be fitted over a respective skeletal member, having a cross-sectional configuration complimentary to the cross-sectional configuration of the skeletal member, and welded to the skeletal member over substantially the entire U-shaped extent of the mounting structure whereby to provide a strong welded attachment of the bracket to the skeletal member and provide stiffening reinforcement for the skeletal member. Each mounting bracket includes a platform portion and a pair of legs outstanding from the platform portion; the platform surface for mounting the respective tooling member comprises one face of the platform portion; and the U-shaped mounting structure is constituted by the pair of legs in coaction with an opposite face of the platform portion.

### RELATED APPLICATION

This application claims the priority of U.S. Provisional Patent Application 60/668,261, filed on Apr. 5, 2005.

### FIELD OF THE INVENTION

This invention relates to a production line framing apparatus for clamping and thereafter welding a loosely assembled vehicle body and more particularly to a framing apparatus that accurately positions and locates predetermined areas of a loosely assembled vehicle body at a welding station for accurately clamping and welding the vehicle body together with a high degree of repeatability between consecutive vehicle bodies on the production line.

### BACKGROUND OF THE INVENTION

The construction of a unitized vehicle body commences with the formation of individual major body panels by stamping the panels from sheet metal blanks. Typically these major panels include a floor panel, right and left body side panels, a fire wall and either a roof panel or transversely extending header members to which a roof panel is subsequently mounted. After the individual panels are stamped, some preliminary assembly operations may then be performed on the individual panels such as, for example, adding door hinge and latch hardware at the body side panels at appropriate locations proximate the door opening, adding seat mounting brackets, adding reinforcements to the body panel, etc.

Next a set of panels that together constitute a sub-assembly of the finished vehicle body is loosely assembled together. This initial loose assembly of panels frequently is accomplished by a “toy tab” arrangement in which one or more panels is formed with a tab which projects from an edge and which is received in a slot in an adjacent panel. This technique interlocks the panels and frame members to each other to thereby form a preliminary loosely assembled vehicle body wherein the panels and frame members will not separate from each other but wherein the panels and frame members are free to tilt or otherwise move relative to one another. This initial loosely-assembled subassembly is then brought, as for example by a pallet riding on rails, to a welding station where the various panels and frames are welded to each other in a rigid permanently assembled relationship. This initial welding operation step at the welding station is one of the most important steps in the assembly of the vehicle body because it establishes the final welding alignment of all of the various panels and headers relative to each other which is essential to subsequent assembly operations performed on the sub-assembly. During the welding operation it is desirable that the various panels and headers be precisely and accurately located and aligned relative to one another and be held fixedly in the desired position. The positioning of the various panels and header members during the welding operation at the welding station is accomplished utilizing a framing apparatus located at the welding station and including a plurality of gates. For example, a pair of side gates may be utilized in combination with a top gate with the gates moveable between retracted positions, to allow the entry of the vehicle assembly into the welding station, and working positions wherein tooling members carried by the gates suitably engage the assembled body panels to fix them into desired finalized positions whereafter programmable welding robots, each provided with a welding gun, perform welding operations on the assembled body components as they are held in place by the gates and the tooling members.

Prior art welding gates tend to be rather bulky and heavy apparatuses due to the necessity of carrying many and sometimes rather complicated and heavy tooling members and this heavy construction of the gates has necessitated cumbersome and expensive power equipment to move the gates between their retracted and working positions. The bulky and heavy construction of the welding gates has also interfered with the ability of the robots to access the vehicle body components located within the gates.

In an attempt to reduce the bulk and weight of the gates, gates having an open frame or skeletal structure have been utilized but these open frame structure gates, by their fragile nature, have difficulty in handling all of the heavy tooling members.

### SUMMARY OF THE INVENTION

This invention is directed to the provision of an improved framing apparatus for use at a car body welding station.

More particularly, this invention is directed to the provision of a framing apparatus utilizing a relatively light weight gate that is yet capable of handling even very heavy tooling members.

The motor vehicle car body framing apparatus of the invention is intended for use at a welding station and includes a gate and a plurality of tooling members carried by the gate for use in positioning components of the vehicle body at the welding station for welding. According to the invention, the gate comprises an open frame structure including skeletal members; the tooling is mounted on the frame structure by a plurality of mounting brackets; and each mounting bracket includes a planar platform surface mounting a respective tooling member and a U-shaped mounting structure sized to be fitted over a respective skeletal member, having a cross-sectional configuration substantially complimentary to the cross-sectional configuration of the skeletal member, and welded to the skeletal member over substantially the entire U-shaped extent of the mounting structure. This mounting bracket construction provides a strong welded attachment of the bracket to the skeletal member and provides stiffening reinforcement for the skeletal member, enabling the mounting of even heavy tooling members on a relatively fragile gate structure.

According to a further feature of the invention, the U-shaped mounting structure of each mounting bracket, when mounted on and welded to the respective skeletal member, extends axially along the skeletal member. This arrangement augments the stiffening reinforcement of the skeletal member by the mounting bracket.

According to a further feature of the invention the U-shaped mounting structure of each mounting bracket is constituted by two axially spaced U-shaped sections each having a cross-sectional configuration substantially complimentary to the cross-sectional configuration of the respective skeletal member. This specific construction further augments the stiffening reinforcement of the skeletal member by the mounting bracket.

According to a further feature of the invention, each mounting bracket includes a platform portion and a pair of legs outstanding from the platform portion; the platform surface comprises one face of the platform portion; and the U-shaped mounting structure is constituted by the pair of legs in coaction with an opposite face of the platform portion. This specific mounting bracket structure facilitates the attachment of a tooling member to the mounting bracket while facilitating the rigid, secure attachment of the mounting bracket to the skeletal member of the frame structure.

According to a further feature of the invention, the platform portion of each mounting bracket defines a plurality of circumferentially spaced apertures for receipt of fastener members. This specific arrangement further facilitates the securement of a respective tooling member to the platform surface.

According to a further feature of the invention, the platform portion is constituted by a plurality of interconnected annular segments arranged about the periphery of the platform portion and each defining a respective aperture. This specific construction provides a convenient means of providing the required platform portion characteristics while also providing aperture means to facilitate the attachment of a tooling member to the mounting bracket.

According to a further feature of the invention, the platform portion has a rectangular configuration with annular segments at each corner of the rectangle, and a leg up-stands from each corner annular segment. This specific configuration is readily manufacturable and facilitates the attachment of the mounting bracket to the skeletal framing structure.

According to a further feature of the invention, each leg defines a first surface and a second surface at a right angle with respect to the first surface; the first surface of each leg is generally parallel to one side of the rectangle; and the second surface of each leg is generally parallel to an adjacent side of the rectangle. This arrangement facilitates abutting engagement with a skeletal member extending parallel to either one side of the rectangle or parallel to the adjacent side of the rectangle, whereby to provide universal mounting.

According to a further feature of the invention, each leg is arranged in non-obstructing relation with respect to the aperture defined by the associated annular segment so as not to interfere with a fastener member extending through the aperture.

According to a further feature of the invention, each platform portion is further constituted by a cruciform structure interconnected to corner segments.

The invention is also directed to a mounting bracket for use with the skeletal gate structure and having the above described characteristics.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic view of a motor vehicle framing production line, including a framing station;

FIG. 2 is a schematic cross-sectional view of the framing station;

FIG. 3 is a perspective view of a gate utilized at the framing station;

FIG. 4 is a side elevational view of the gate;

FIG. 5 is a perspective view of the gate viewed from below the gate;

FIG. 6 is a side elevational view of the gate shown in association with tooling members and vehicle body components engaged by the tooling members;

FIGS. 7 and 8 are perspective views of a mounting bracket for use in mounting tooling members on the gate;

FIG. 9 is a plan view of a mounting bracket;

FIGS. 10 and 11 are fragmentary views showing the mounting of a mounting bracket on the gate;

FIG. 12 is a plan view of an alternate form of mounting bracket; and

FIGS. 13-16 are views of a further alternate form of mounting bracket.

### DETAILED DESCRIPTION OF THE PREFERRED EMBODIMENT

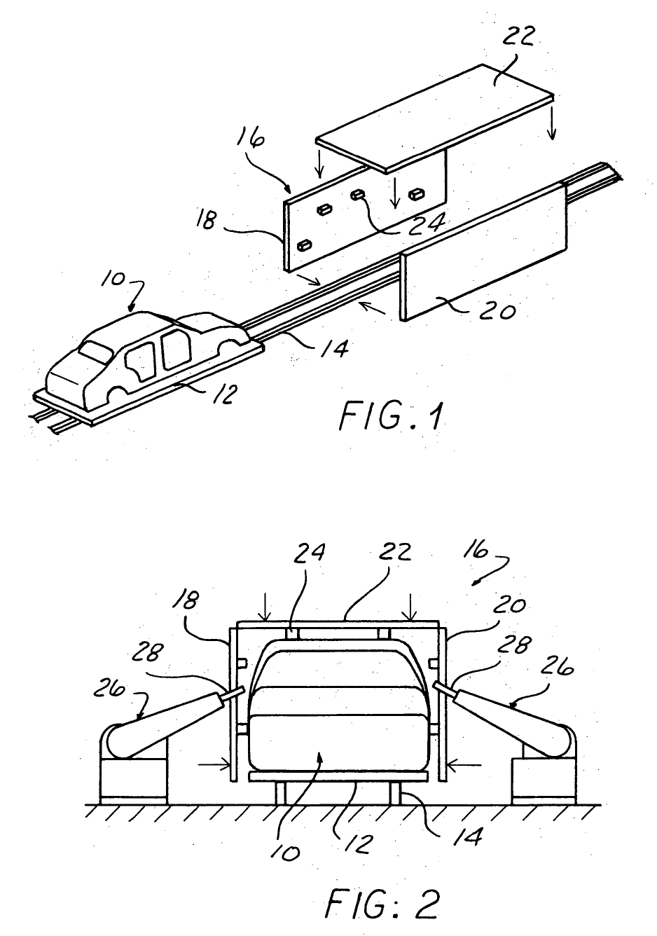

With reference to FIG. 1, an initial loosely assembled body sub-assembly, seen generally at 10, is brought, as for example by a pallet 12 riding on rails 14, to a welding station 16 where the various panels and frames are welded to each other in a rigid permanently assembled relationship. The positioning of the various panels and header members during the welding operation at the welding station is accomplished utilizing a framing apparatus 15 including a plurality of gates. For example, as seen schematically in FIG. 1, a pair of side gates 18 and 20 may be utilized in combination with a top gate 22 with the gates moveable between retracted positions seen in FIG. 1, to allow the entry of the vehicle assembly 10 into the welding station, and working positions seen in FIG. 2, wherein tooling members 24 carried by the gate suitably engage the assembled body panels to fix them into desired finalized positions whereafter programmable welding robots 26, each provided with a welding gun 28, perform welding operations on the assembled body components as they are held in place by the gates 18, 20 and 22 and the tooling members 24.

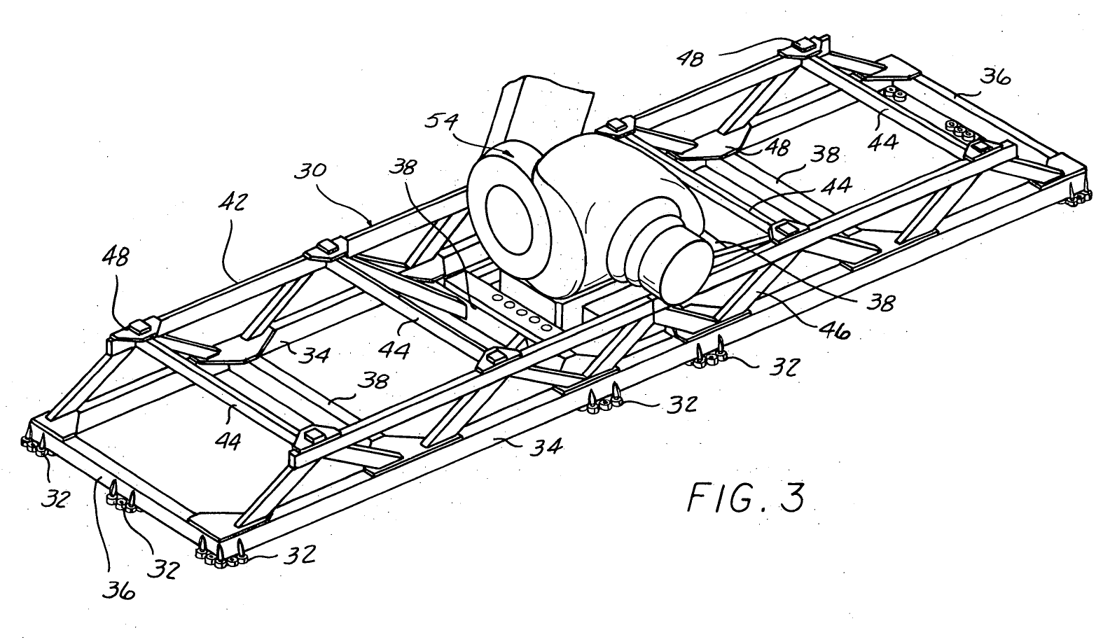

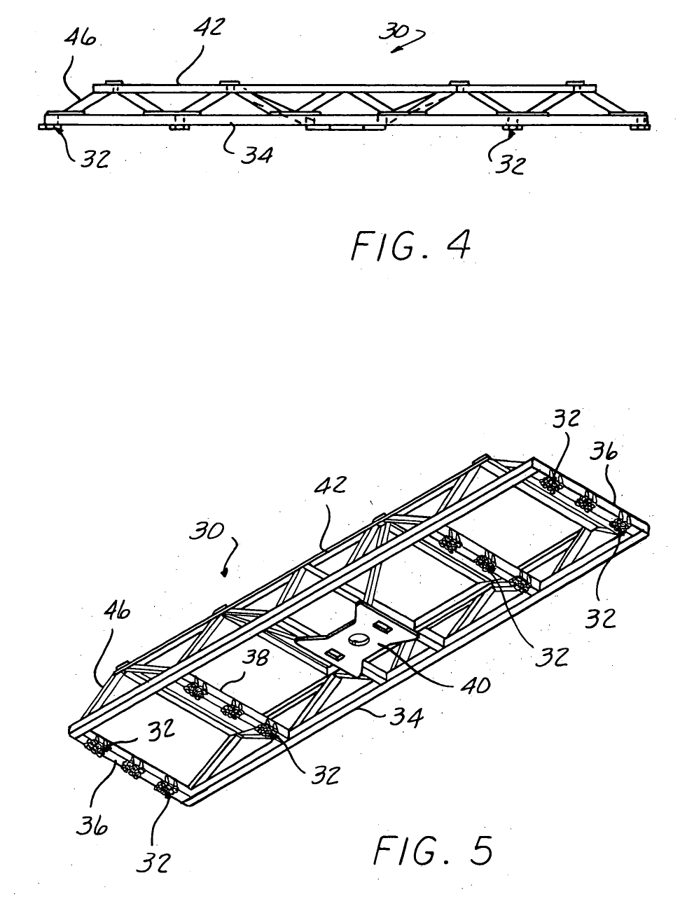

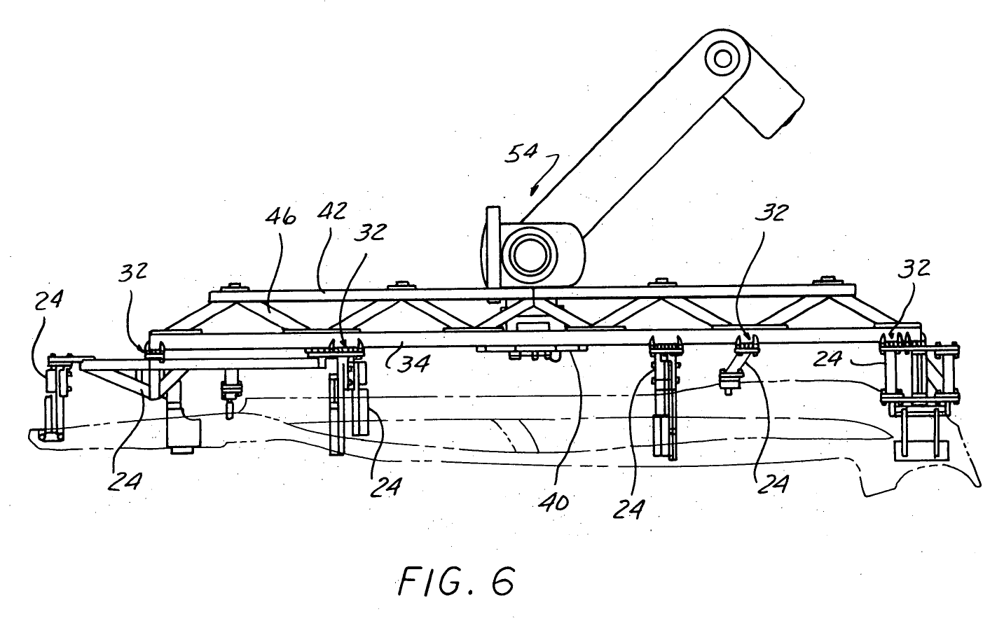

The framing apparatus of the invention uses an open frame gate structure 30 (FIGS. 3-6) in combination with a plurality of mounting brackets or “pucks” 32 to facilitate attachment of the tooling members to the gate. Gate 30, which may comprise either a top gate or a side gate, has an open frame skeletal structure comprising skeletal, parallel, longitudinal side members 34, skeletal end cross-members 36, skeletal immediate cross-members 38, a central mounting plate 40, skeletal upper parallel side rails 42, skeletal upper cross-members 44, and lattice members 46 interconnecting each upper side rail to the respective lower rail. All of the members of the frame are preferably formed of a lightweight tubular material of rectangular cross-section having a wall thickness of, for example, 60 thousandths of an inch and all of the members are formed of a suitable ferrous material. The frame components are secured together by welding utilizing suitable gussets 48.

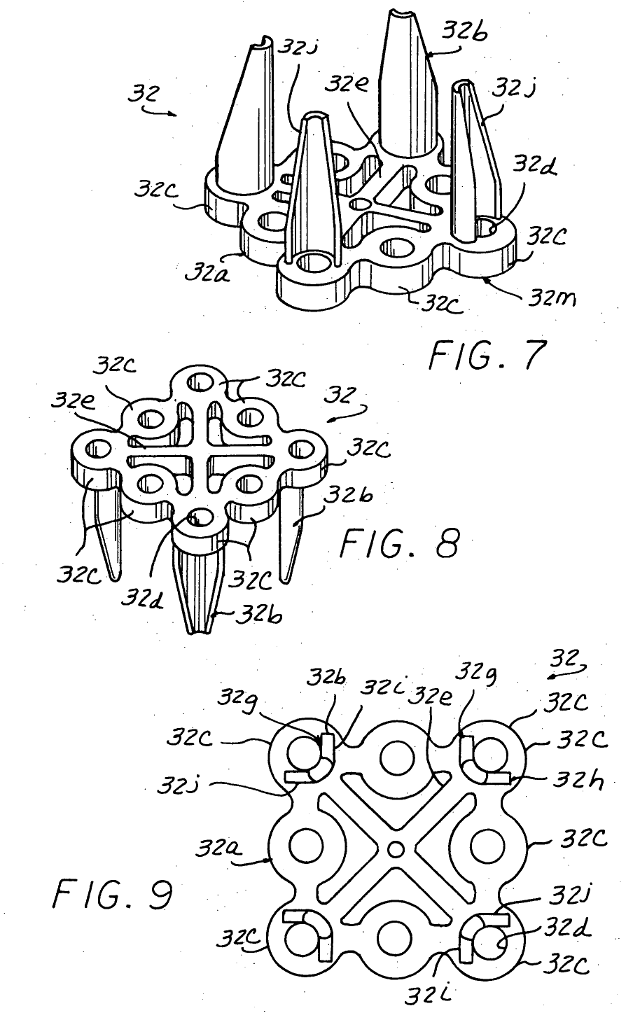

Each mounting bracket 32 (FIGS. 7-11) is formed as a cast, ferrous structure and includes a planar platform portion 32a and a plurality of legs 32b integrally upstanding from the platform portion.

Platform portion 32a is constituted by a plurality of interconnected annular segments 32c arranged around the periphery of the platform portion and each defining a central aperture 32d. The platform portion has a square configuration with annular segments 32c at each corner of the rectangle, and a leg 32b up-stands from each corner annular segment. Adjacent annular segments 32c are integrally interconnected by bridge portions and the platform portion is further constituted by a cruciform structure 32e integrally interconnected to corner segments 32c.

Each leg 32b has a right angular cross-sectional configuration including a first leg section 32g and a second leg section 32h arranged at right angles with respect to the leg section 32g. Each leg section 32g will be seen to define a first flat surface 32i and each leg section 32h will be seen to define a second flat surface 32j at right angles with respect to the respective surface 32i. Each leg is arranged in non-obstructing relation with respect to the aperture 32d defined by the associated annular segment 32c so as not to interfere with a fastener or stud passing through the aperture. Each leg preferably has an upwardly tapered configuration with a relatively wide base structure corresponding generally to the overall configuration of the associated annular segment 32c and a relatively narrow free end tip structure 321 with the relatively wide base structure and the relatively narrow tip structure interconnected by angled edge surfaces 32k.

It will be seen that the lower face of each planar platform portion 32a constitutes a planar platform surface 32m and the upper face 32n of each planar platform portion cooperates with a respective pair of legs 32b to define a U-shaped mounting structure sized to fit over a respective skeletal gate member 32, 34, 36 or 38. In the specific construction shown wherein the bracket has a square configuration, it will seen that the four corner legs co-act to define two axially-spaced U-shaped, rectangulated sections, each having a cross-sectional configuration complementary to the rectangular cross-sectional configuration of a respective skeletal member 32, 34, 36 or 38.

In use, and as best seen in FIGS. 3, 6, 10 and 11, at each location on a skeletal member 34, 36 or 38 of the gate where it is desired to mount a tooling member 24, a puck or bracket 32 is positioned beneath the respective skeletal member of the gate in a cradling relationship with respect to the skeletal member so that the U-shaped sections defined by the upstanding legs, in co-action with the upper face 32n of the platform portion, are complementary to the cross-sectional configuration of the respective skeletal member to provide a U-shaped interface as between the bracket and the skeletal member and specifically, in the case of the square cross-section bracket an rectangular cross section skeletal member shown, provide two axially-spaced, U-shaped sections, each having a rectangular cross-sectional configuration complementary to the rectangular cross-sectional configuration of the respective skeletal member. With this arrangement, the U-shaped mounting structures of the mounting bracket may be welded to the respective skeletal member over substantially the entire interface 34 between the U-shaped mounting structures and the skeletal member, whereby to provide a firm, rigid mounting of the bracket on the skeletal member.

Thus fixedly welded to the skeletal member, the lower planar platform surface 32m of the bracket is positioned to mount a respective tooling member 24 utilizing suitable fasteners and/or studs secured to the respective tooling member and passing upwardly through the respective apertures 32d provided by the annular segments 32c. As noted, the upwardly projecting members passing through the apertures 32d may constitute threaded members for coaction with nuts or they may simply constitute smooth shanks for positioning or piloting purposes. The described mounting structure not only provides a strong welded attachment of the bracket to the skeletal member, but also provides stiffening reinforcement for the skeletal member by virtue of the pair of axially-spaced, U-shaped sections each having a cross-sectional configuration complementary to the cross-sectional configuration of the respective skeletal member and each welded to the respective skeletal member over the entire U-shaped interface with the skeletal member.

Note that the described construction also provides a universal mounting in that the bracket or puck may be fitted in any orientation over the respective skeletal member with the surfaces 32i in one orientation extending parallel to and engaging the side faces of the skeletal member and with the surfaces 32j in the other orientation extending parallel to and engaging the side faces of the skeletal member.

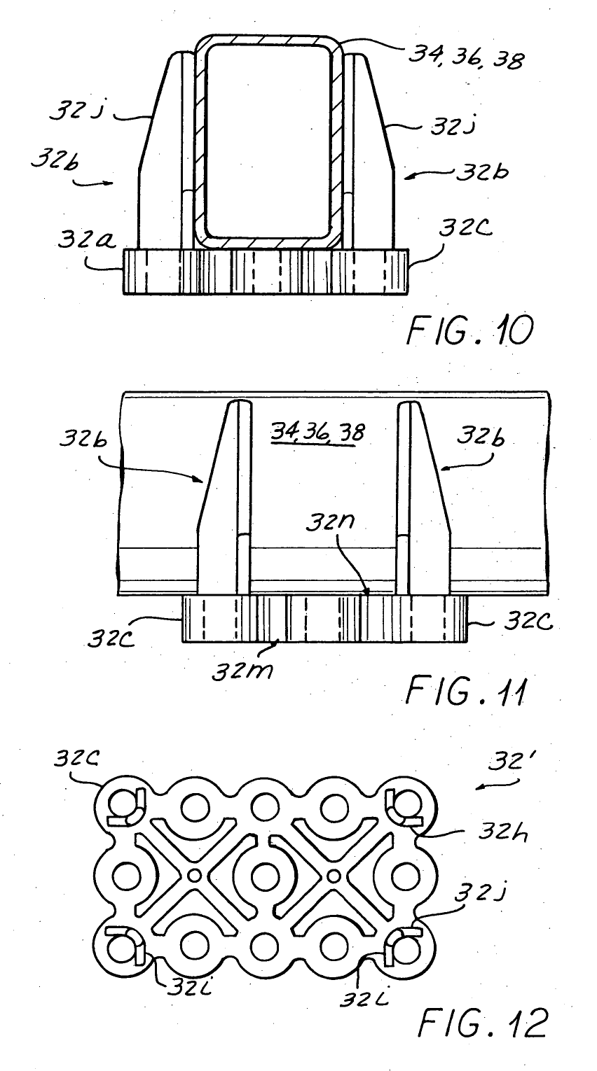

In the alternate mounting bracket construction seen in FIG. 12, the bracket 32 has a non-square, rectangular configuration with legs 32b upstanding from each corner of the rectangle. With this configuration, surfaces 32h on adjacent legs on the short side of the rectangle are spaced apart a first distance to accommodate a relatively narrow gate skeletal member and surfaces 32i of adjacent legs on the long side of the rectangle are spaced apart a second, greater distance to accommodate a wider skeletal member.

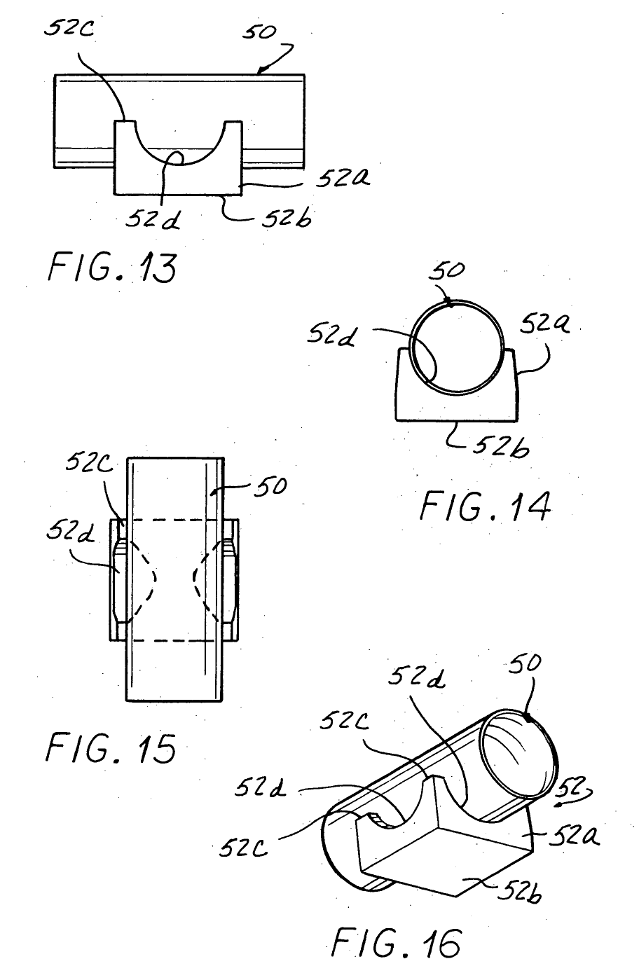

The alternate mounting bracket structure seen in FIGS. 13-16 is intended for use with skeletal members having a circular cross-sectional configuration such as the skeletal member seen at 50. The bracket or puck 52 for coaction with the circular cross-section skeletal member 50 will be seen to provide a platform portion 52a, defining the planar platform surface 52b for the mounting of a respective tooling member, and legs 52c upstanding from each corner of the platform portion with the legs configured to provide a circular interconnecting surface 52d between adjacent legs complementary to the circular, cross-sectional configuration of the skeletal member 50 so that, as with the embodiments of FIGS. 1-12, axially-spaced U-shaped mounting structures are provided, each having a cross-sectional configuration complementary to the cross-sectional configuration of the respective skeletal member whereby to provide a strong welded attachment of the bracket to the skeletal member and further provide stiffening reinforcement for the skeletal member. Apertures 52e are provided in platform portion 52a, opening downwardly in platform surface 52b, to facilitate mounting of a tooling member on the platform surface. Note that a circular, interconnecting surface 52d is provided between all of the legs so that the bracket has a universal mounting with respect to the skeletal member.

Irrespective of the specific mounting bracket structure employed, it will be seen that the mounting bracket, by virtue of its firm welded connection to the skeletal member of the gate and by virtue of the axial reinforcement of the skeletal member by the axially-spaced mounting portions of the bracket, allows the use of a lightweight skeletal gate which in turn allows the use of a robotic structure, such as the robot 54 secured to frame mounting plate 40, to position the gate relative to the body structure, thereby eliminating the need for the heavy, complex and expensive power equipment previously required to move the heavy gates into and out of their welding positions. The lightweight, open skeletal structure of the gate also augments the ability of the welding robots to access the vehicle body subassembly positioned within the gates at the welding station.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A motor vehicle car body framing apparatus for use at a welding station, the apparatus including a gate and a plurality of tooling members carried by the gate for use in positioning components of the vehicle body at the welding station for welding, characterized in that:
the gate comprises an open frame structure including skeletal members;
the tooling members are mounted on the frame structure by a plurality of mounting brackets; and
each mounting bracket includes a planar platform surface mounting a respective tooling member and a U-shaped mounting structure sized to be fitted over a respective skeletal member, having a cross-sectional configuration substantially complimentary to the cross-sectional configuration of the skeletal member, and welded to the skeletal member over substantially the entire U-shaped extent of the mounting structure whereby to provide a strong welded attachment of the bracket to the skeletal member and provide stiffening reinforcement for the skeletal member.

2. A framing apparatus according to claim 1 wherein the U-shaped mounting structure of each mounting bracket, when mounted on and welded to the respective skeletal member, extends axially along the skeletal member to facilitate the stiffening reinforcement.

3. A framing apparatus according to claim 2 wherein the U-shaped mounting structure of each mounting bracket is constituted by two axially spaced U-shaped sections each having a cross-sectional configuration complementary to the cross-sectional configuration of the respective skeletal member.

4. A framing apparatus according to claim 2 wherein:
each mounting bracket includes a platform portion and a pair of legs outstanding from the platform portion;
the planar platform surface comprises one face of the platform portion; and
the U-shaped mounting structure is constituted by the pair of legs in co-action with an opposite face of the platform portion.

5. A framing apparatus according to claim 4 wherein the platform portion of each mounting bracket defines a plurality of circumferentially spaced apertures for receipt of fastener members to secure a respective tooling member to the platform surface.

6. A framing apparatus according to claim 5 wherein the platform portion is constituted by a plurality of inter-connected annular segments arranged about the periphery of the platform portion and each defining a respective aperture.

7. A framing apparatus according to claim 6 wherein:
the platform portion has a rectangular configuration with annular segments at each corner of the rectangle; and
a leg upstands from each corner annular segment.

8. A framing apparatus according to claim 7 wherein each leg defines a first surface and a second surface at a right angle with respect to the first surface.

9. A framing apparatus according to claim 8 wherein:
the first surface of each leg is generally parallel to one side of the rectangle, whereby to facilitate abutting engagement with a skeletal member extending parallel to the one side of the rectangle; and
the second surface of each leg is generally parallel to an adjacent side of the rectangle, whereby to facilitate abutting engagement with a skeletal member extending parallel to the adjacent side of the rectangle.

10. A framing apparatus according to claim 9 wherein each leg is arranged in non-obstructing relation with respect to the aperture defined by the associated annular segment so as not to interfere with a fastener member extending through the aperture.

11. A framing apparatus according to claim 7 wherein each platform portion is further constituted by a cruciform structure interconnected to corner segments.

12. A mounting bracket for use in a motor vehicle car body framing apparatus located at a welding station, the framing apparatus including a gate positioned at the welding station having an open frame structure including skeletal members, and a plurality of tooling members carried by the gate for use in positioning components of the vehicle body at the welding station for welding, each tooling member mounted on the gate by a mounting bracket, characterized in that:
each mounting bracket includes a planar platform surface for mounting a respective tooling member and a U-shaped mounting structure sized to be fitted over a respective skeletal member, having a cross-sectional configuration substantially complementary to the cross-sectional configuration of the skeletal member, and adapted to be welded to the skeletal member over substantially the entire U-shaped extent of the mounting structure whereby to provide a strong welded attachment of the bracket to the skeletal member and provide stiffening reinforcement for the skeletal member.

13. A mounting bracket according to claim 12 wherein the U-shaped mounting structure of the mounting bracket, when mounted on and welded to the respective skeletal member, extends axially along the skeletal member to facilitate the stiffening reinforcement.

14. A mounting bracket according to claim 13 wherein the U-shaped mounting structure of each mounting bracket is constituted by two axially spaced U-shaped sections each having a cross-sectional configuration complementary to the cross-sectional configuration of the respective skeletal member.

15. A mounting bracket according to claim 13 wherein:
the mounting bracket includes a platform portion and a pair of legs outstanding from the platform portion;
the planar platform surface comprises one face of the platform portion; and
the U-shaped mounting structure is constituted by the pair of legs in co-action with an opposite face of the platform portion.

16. A mounting bracket according to claim 15 wherein the platform portion of the mounting bracket defines a plurality of circumferentially spaced apertures for receipt of fastener members to secure a respective tooling member to the platform surface.

17. A mounting bracket according to claim 16 wherein the platform portion is constituted by a plurality of inter-connected annular segments arranged about the periphery of the platform portion and each defining a respective aperture.

18. A mounting bracket according to claim 17 wherein:
the platform portion has a rectangular configuration with annular segments at each corner of the rectangle; and
a leg upstands from each corner annular segment.

19. A mounting bracket according to claim 18 wherein each leg defines a first surface and a second surface at a right angle with respect to the first surface.

20. A mounting bracket according to claim 8 wherein:
the first surface of each leg is generally parallel to one side of the rectangle, whereby to facilitate abutting engagement with a skeletal member extending parallel to the one side of the rectangle; and
the second surface of each leg is generally parallel to an adjacent side of the rectangle, whereby to facilitate abutting engagement with a skeletal member extending parallel to the adjacent side of the rectangle.

21. A mounting bracket according to claim 20 wherein each leg is arranged in non-obstructing relation with respect to the aperture defined by the associated annular segment so as not to interfere with a fastener member extending through the aperture.

22. A mounting bracket according to claim 18 wherein each platform portion is further constituted by a cruciform structure interconnected to corner segments.
